(19) United States
(12) Patent Application Publication
(10) Pub. No.: US 2003/0101254 A1
(43) Pub. Date: May 29, 2003

(54) Management system and method

(75) Inventor: Kazuhiko Sato, Tokyo (JP)

Correspondence Address: ALLEN BLOOM, C/O DECHERT, PRINCETON PIKE CORPORATION CENTER, P.O. BOX 5218, PRINCETON, NJ, 08543-5218, US

(73) Assignee: Allied Telesis Kabushiki Kaisha, Tokyo (JP)

(21) Appl. No.: 10/231,585

(22) Filed: Aug. 30, 2002

(30) Foreign Application Priority Data
Nov. 27, 2001 (JP) 2001-361715

(51) Int. Cl. G06F 15/173

(52) U.S. Cl. 709/223; 709/224

(57) ABSTRACT

A management system includes a plurality of managed devices connected to a network and classified into one or more groups, each of which is given priority order, and a management device, connected to the network, for managing the plurality managed devices, the management device including a control part for differently managing said managed devices in accordance with the priority order.

### BACKGROUND OF THE INVENTION

The present invention relates generally to a management system for managing a computer network. The present invention is suitable for a management system for managing security and network in a facility that lays out a computer network, such as a LAN (Local Area Network), using a management server (or device).

Along with recently spread LANs and WANs (Wide Area Networks), a large number of network devices, such as personal computers (“PCs” hereinafter), hubs, switches, and routers (hubs etc. are often called “agents”) have been connected to a network and its subnet(s) for frequent information sharing and communications. For example, a school has laid out a network, e.g., a LAN system using a concentrator to connect a plurality PCs so as to catch up with a recent information-oriented society. These multiple PCs are managed devices including those for students in class, those for teachers, and those for school administrative purposes, and share information through the network. A management device provided on a network manages the network for these PCs.

As the number of managed devices increases, the management device should bear more burdensome managements. The overload would result in insufficient network managements and information leakages from a PC, the information including, for example, students' domestic information, roll book information, report card information, and examination information. The conventional managed devices are easily available to anyone in the school, and it has been difficult to restrict or eliminate unauthorized use.

A facility, such as a school, often entrusts a security corporation to manage the facility at night, but the security corporation can neither maintain the network system secure, nor sufficiently prevent an authorized person from causing injury and robbery.

### BRIEF SUMMARY OF THE INVENTION

Accordingly, it is an exemplified object of the present invention to provide a management system and method for managing a plurality of managed devices in a network in a facility, such as a school, based on a predetermined management content.

In order to achieve the above objects, a management system includes a plurality of managed devices connected to a network and classified into one or more groups, each of which is given priority order, and a management device, connected to the network, for managing the plurality managed devices, the management device including a control part for differently managing the managed devices in accordance with the priority order. This management system may make the management device provide different managements according to the priority order assigned to classified groups, and reduce the management load for the management device, for example, by reducing the scope of the management content if needed. In addition, the management system may provide strict management content for some group, enhancing the network security. In this way, it does not provide the same management for all of the plural managed devices, contributing to the reduced management load for the management device.

The management system may further include an interconnecting device for connecting the managed devices and management device, wherein the control part sets up the interconnecting device so that the network may be logically divided among the plurality of managed devices, thereby grouping the managed devices. The VLAN for use with this group configuration firmly maintains the security among different groups. The higher priority order may be given to a higher security level required for one of the groups so that two managed devices are classified in the same group when these two managed devices apply the same security level on the network, wherein the control part manages the managed device with respect to more management items where the managed device is classified into one of the groups having the higher priority order. In such a management system, the management item may include a user of the managed device, date and time of use of the managed device, accumulated amount of time of use of the managed device, and access log on the network of the managed device.

In the above management system, the managed device may include a drive for reading an information record carrier, and a first communication part for communicating with the management device through the network, and for sending first information read out from the information record carrier to the management device, wherein the management device further includes a storage part for storing user information on users who may use the managed devices, and a second communication part for communicating with the managed device through the network, wherein the control part sends second information to the managed device so as to enable a user to use the managed device when the first information received from the managed device corresponds to the user information stored in the storage part. This management system may utilize the management device to allow the managed device to enter a school and classroom(s), use a locker, and a PC. For example, this management system may use the information record carrier as an IC card.

A management method of another aspect of the present invention for managing a network to which a plurality of managed devices and a management device are connected includes the steps of the management device determining a management content for a plurality of managed devices classified into one or more groups, each of which is given priority order, and the management device performing the management content for the managed device that has logged in the network, the management content corresponding to the priority order of the managed device. This management system determines the management content to be performed by the management device, and executes different managements based on the management content, reducing the management load. This method may exhibit the similar operation to those of the above management system since it serves as a method to implement the management system.

A management device of still another aspect of the present invention includes a communication part for communicating with a plurality of managed devices through a network, and a control part for differently managing the managed devices in accordance with priority order that has been assigned to one or more groups into which the managed devices are classified. According to this management device, the control part reduces the management load of the management device by changing management content according to the managed devices instead of performing the same management for all of the managed devices. It achieves flexible managements by assigning those which require an elaborate management to the high priority order.

The management device may further include a storage part for storing management logs for each managed device. The storage part stores the management logs to confirm the history and to find out unauthorized users. A record of the management history of the managed device would be a deterrent potential of unauthorized use. The management may include a user of the managed device, date and time of use of the managed device, accumulated amount of time of use of the managed device, and access log on the network of the managed device.

The management device may further include a storage part for storing user information on users who may use the managed devices, wherein the control part sends second information to the managed device so as to enable a user to use the managed device when the first information received from the managed device corresponds to the user information stored in the storage part. This management device authenticates information sent from the managed device to authorize its use. This authentication may restrict use of the managed device, such as a PC. When the managed device serves, for example, as a device to restrict admittance to a school and classroom, as described later, a device to restrict use of a locker, the school may be managed through the management device. The user information may include a user's name, identifier assigned to the user, account number, access information necessary for the network, and communication parameter for making the managed device identifiable on the network.

A method of another aspect of the present invention for managing a plurality of managed devices connected to a network includes the steps of classifying a plurality of managed devices into one or more groups, assigning priority order to each of the groups, determining for the managed device a management content that is different according to the priority order, and managing the managed device based on the management content determined by the determining step. A method of another aspect of the present invention for managing a plurality of managed devices connected to a network include the steps of storing in a memory management contents that are different according to priority order of the managed devices that have been classified into one or more groups, each of which is given the priority order, and managing the managed device based on the management content stored in the memory. These management methods enable the above devices to perform managements for the managed device, and may exhibit similar operations as those of the above devices. The managing step records a management logs for each managed device in the memory.

A method of still another aspect of the present invention for authenticating an availability of a managed device connected to a network includes the steps of storing, in a memory, information on users who may use the managed device, receiving first information sent from the managed device through the network, determining whether the first information received corresponds to the information on users stored in the memory, and informing the managed device of second information that allows a user to use the managed device when the determining step determines that the first information corresponds to the information on users. The management method enables the above management device to manage use of the managed device, and may exhibit similar operations as those of the above devices.

A computer program of another aspect of the present invention for enabling a computer to managing a plurality of managed devices connected to a network includes the steps of obtaining a priority order of the managed devices when the managed device accesses the network, the managed devices being classified into one or more groups, each of which is given the priority order, and performing a management corresponding to the priority order obtained by the obtaining step. A computer program of still another aspect of the present invention for enabling a computer to authenticating an availability of a managed device connected to a network includes the steps of authenticating first information sent from a managed device, and generating second information that allows a user to use the managed device. These computer programs enable the computer to serve as the inventive management device and to exhibit the above operations.

A managed device of another aspect of the present invention connected to a network and serving as a client includes a drive for reading an information record carrier, a communication part, connected to the network, for communicating, through the network, with a management device that manages the managed device, and a control part that makes the managed device available when the management device authenticates information read out by the drive. This managed device communicates with the management device and the management device authenticates the information, making the managed device available to the users, and preventing unauthorized use of the managed device. The managed device may be implemented as a PC, for example.

The managed device may further include an operation part for executing a predetermined action, wherein the control part allows the operation part to execute the predetermined action when the management device authenticates information read out by the drive. For example, the operation part includes a key to restrict admittance to a predetermined area, wherein the control part opens the key when the management device authenticates information read out by the drive. The management device communicates with the managed device and thus restricts the admittance to the school and classroom. The operation part may include a key to restrict use of a locker, wherein the control part opens the key when the management device authenticates information read out by the drive. The management device communicates with the managed device and thus restricts the use of the locker. For example, the operation part may serve to settle outstanding bills, wherein the control part allows the settlement when the management device authenticates information read out by the drive. The management device communicates with the managed device and thus processes the settlement of the outstanding bills.

A method of another aspect of the present invention for restricting availability of a managed device connected to a network includes the steps of reading an information record carrier through a drive, sending information read by the reading step to a management device that is connected to the network and manages the managed device, receiving an authentication result from the management device for the information sent from the sending step, and making the managed device available when the management device authenticates the information and making the managed device unavailable when the management device does not authenticate the information. This management method restricts use of the managed device based on the authentication result by the management device, preventing unauthorized use of the managed device.

Other objects and further features of the present invention will become readily apparent from the following description of preferred embodiments with reference to accompanying drawings.

### BRIEF DESCRIPTION OF THE DRAWINGS

FIG. 1 is a structural view of a management system of the present invention.

FIG. 2 is a schematic block diagram of a management device in the management system shown in FIG. 1.

FIG. 3 is a schematic block diagram of an exemplary stored content of a storage part shown in FIG. 2.

FIG. 4 is an exemplary table stored in a personal information database shown in FIG. 3.

FIG. 5 shows an exemplary table stored in a management database shown in FIG. 3.

FIG. 6 exemplarily shows information to be stored in an IC card.

FIG. 7 shows a block diagram of the exemplary managed device shown in FIG. 1.

FIG. 8 shows another block diagram of the exemplary managed device shown in FIG. 1.

FIG. 9 is a flowchart for explaining an operation of the management system shown in FIG. 1.

FIG. 10 is another flowchart for explaining an operation of the management system shown in FIG. 1.

### DETAILED DESCRIPTION OF THE PREFERRED EMBODIMENTS

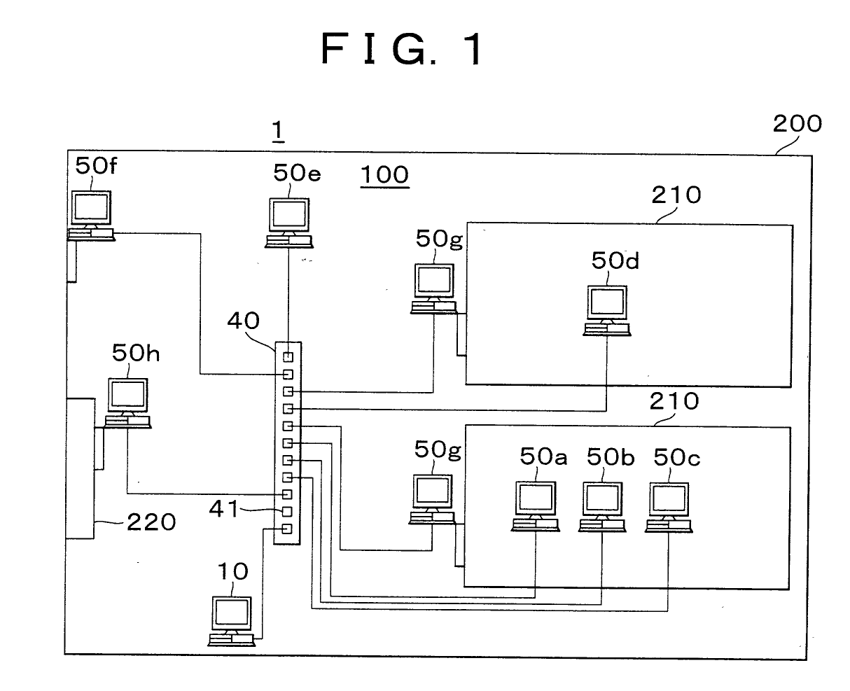

A description will now be given of an inventive management system 1, with reference to the accompanied drawings. Here, FIG. 1 is a structural view of the management system 1. The inventive management system 1 includes a management device 10, an interconnecting device 40, and a plurality of network devices 50 (i.e., 50a-50h), and is applied to a school 200. This structure forms a network 100 including the management device 10 connected to the interconnecting device 40. The interconnecting device 40 includes a router so that the management device 10 and managed devices 50 may be connected to the Internet.

The managed device 50 exemplarily includes and generalizes eight managed devices 50a-50h with alphabetical letters in FIG. 1. The managed device 50 may include more managed devices, in addition to the managed devices 50a-50h, which have the same, additional or different functions.

The management device 10 controls connection statuses and traffic of the managed devices 50 through the interconnecting device 40. For example, the management device 10 may obtain, from the interconnecting device 40, traffic and/or communication time, and an access state for each port 41 in the interconnecting device 40. In this embodiment, the management device 50 manages the managed devices 50 according to the priority order, which managed devices 50 are classified into one or more groups to each of which the priority order is assigned. In other words, the management device 10 differently manages the managed devices 50 according to groups into which the managed devices 50 are classified, as described in detail later. The assignment of the priority order to the groups would lessen the management burden by the management device 10, because the management devices 10 may perform a management of decreased burden for some managed device(s) 50.

The management device 10 in this embodiment communicates with the managed device 50 to control or manage equipment in the school 200, for example, admittance to the school 200, admittance to the room 210, use of the locker 220, and use of the managed device 50.

Although not described in detail, the management device 10 manages the network 100 using a Dynamic Host Configuration Protocol (“DCHP”) for providing the interconnecting devices 40 and managed devices 50 with communication parameters for identifying them in the network 100. The communication parameter includes an IP address, a subnet mask, and a default gateway. This network management may use any technique known in the art, and thus a detailed description will be omitted. A method for providing the communication parameter may use any technique known in the art including the management device 10 assigning the communication parameter to the managed device 50 when recognizing power on of the managed device 50. Alternatively, the IC card 30 which will be described later stores a unique communication parameter, and the managed device 50 reads out the IC card 30 when the communication parameter is assigned to the managed device 50.

The management device 10 in the present embodiment is exemplarily a desktop PC, to which an IC card drive 20 is attached externally or internally. A contact-type IC card 30 is used for the IC card drive 20, but the noncontact-type IC card is not excluded from application to the present invention. Further, the present invention is also applicable to information record carrier other than the IC card, such as a PC card, and a memory card.

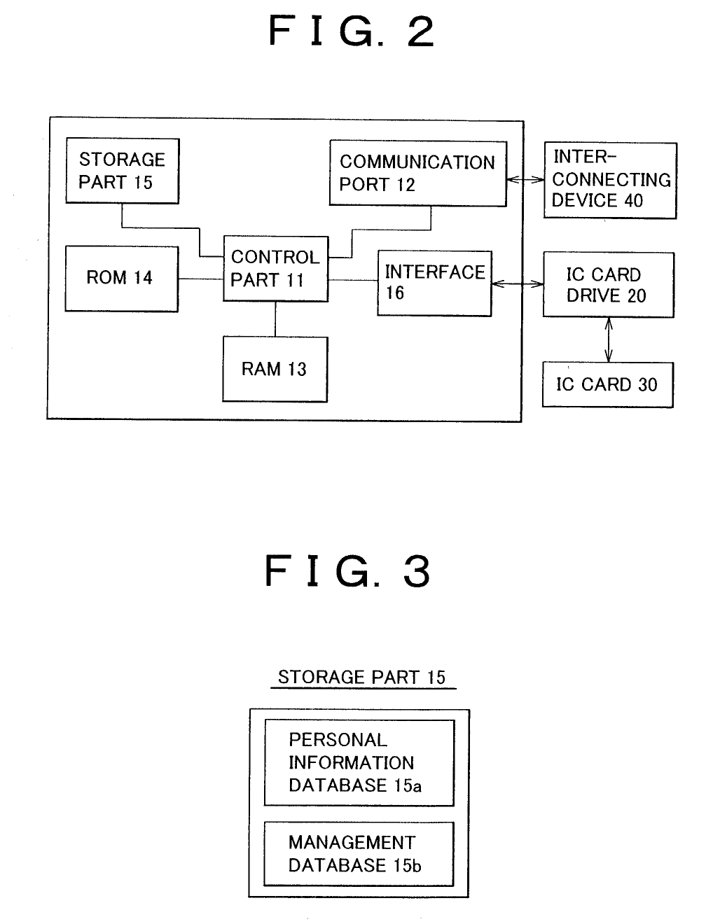

The management device 10 includes, as shown in FIG. 2, a control part 11, a communication port 12, a RAM 13, a ROM 14, a storage part 15, an interface 16, and the IC card drive 20. Here, FIG. 2 is a schematic block diagram of the management device 10. In FIG. 2, input/output devices (e.g., a keyboard, a mouse or other pointing devices, and a display) attached to the management device 10 are omitted. Through the input/output device, an operator of the management device 10 may control the IC card drive 20, input data of various kinds in the storage part 15, and download necessary software into the RAM 13, and ROM 14 or storage part 15.

The control part 11 covers a broad range of processors such as a CPU and an MPU regardless of its name, and controls each section in the management device 10. In this embodiment, the control part 11 manages the managed device 50 based on personal information database 15a and management database 15b stored in the storage part 15. The control part 11 may prepare and update the personal information database 15a and management database 15b.

As will be apparent from the following description of operation, the control part 11 communicates with the managed device 50 by referring to the personal information database 15a, and manages admittance to the school 200 and its rooms 210 including a classroom and teachers' room, use of lockers 220, settlement, and use of managed device 50. For example, the control part 11 may communicate with the managed device 50 to authorize a user to use the managed device 50. It is noted that “use” of the managed device 50 does not include use of the managed device 50 for authentication purposes. In essence, the managed device 50 is always open to users for authentication purposes.

The control part 11 manages managed devices 50 according to the priority order assigned to each group. The managed devices 50 are classified into one or more groups to which the priority order is assigned. For example, the control part 11 may enhance or mitigate a monitoring level in the ascending or descending order of the priority order. It is one feature of the present invention that the control part 11 changes the management content for the managed devices 50 according to the priority order.

In this embodiment, the highest priority order is assigned to the managed devices 50a-50c for use with the school staffs and teachers, which are used to administrate the school 200 including test information, expense, students' scholastic marks, etc. The relatively low priority order is assigned to the managed device 50d used for students and the management device 50f used to manage admittance to the school 200. In such a structure, the control part 11 enhances the monitoring content for the high priority order. The control part 11 monitors the user's name, date and time of use, the amount of time of use, access log, etc, and executes at least one management content for the managed device 50 having the low priority order.

The control part 11 does not provide the same management content to the managed devices 50 which have been classified into a plurality of groups but provide different management content to the managed devices 50 according to the groups, lessening the management load of the management device 10 or the control part 11. The high priority order is assigned to those groups which require elaborate managements. This system may minimize the management load of the management device even when the number of the managed devices 50 increases.

Of course, the above assignment of the priority order is for illustrative purposes, and the administrator (or a person who uses the inventive system 1) may arbitrarily determine the priority order according to his desired management system.

In this embodiment, the control part 11 may set up the interconnecting device 40 so that the same VLAN is assigned to the managed devices 50 in one group or in order to logically divide the groups. The control part 11 does not necessarily have to apply the VLAN in classifying the managed devices 50 as far as it may recognize them. The VLAN may enhance the security of the network 100 by intercepting communications between different groups.

The communication port 12 may be an LAN adapter connected to the interconnecting devices 40, and a USB port or IEEE 1394 port for providing connections to the Internet (if necessary, via an Internet Service Provider (ISP)) via a modem, or a terminal adapter (TA) through the public telephone network, ISDN, or various types of dedicated lines.

The RAM 13 temporarily stores data to be read from the ROM 14 and storage part 15, data to be written in the storage part 15, and the like. The ROM 14 stores various kinds of software and firmware required for operations of the control part 11, and other types of software.

The storage part 15 stores, as shown in FIG. 3, the personal information database 15a and the management database 15b. Here, FIG. 3 is an exemplary block diagram of the contents of the storage part 15 shown in FIG. 2.

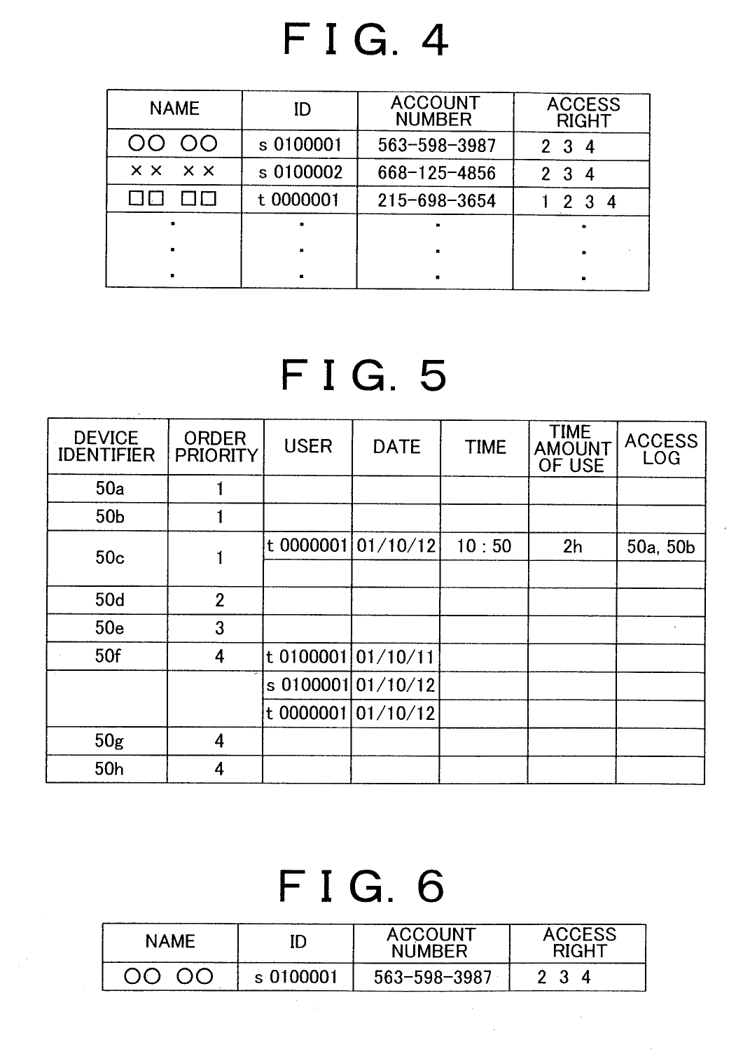

The personal information database 15a stores information on relevant people including students, teachers and staffs of the school 200. The personal information database 15a includes, as shown in FIG. 4, a table reciting a name, an ID, an account number, and an access right. Here, FIG. 4 shows an exemplary table to be stored in the personal information database 15a shown in FIG. 3.

A “name” field stores names of concerned or relevant people of the school 200 including students, teachers and school staffs. An “ID” field stores identifiers of the relevant people including registration numbers, etc. Each ID is preferably unique in the school 200. The ID may employ a communication parameter of the network 100 assigned to the managed device 50. The communication parameter usable to the ID includes, for example, an IP address, a subnet mask, a gateway default, and a combination thereof. An “account number” field stores account number information of a bank account, credit number, electronic money account, and the like from which a bill is automatically deducted. An “access right” field indicates an available group of the managed devices 50. This embodiment classifies the managed devices 50 into four groups to which the priority orders 1 to 4 are assigned. The number in the priority order field corresponds to the group number.

As discussed above, the present invention does not restrict the personal information database 15a from including additional fields. Therefore, an administrator may add or delete arbitrary fields or partially change the fields if necessary.

According to the personal information database 15a, the control part 11 authenticates use of the managed devices 50, admittance to the school 200 and rooms 210, and use of lockers 220, by referring to the personal information database 15a and authenticating information stored in the IC card 30 sent from the managed device 50.

The management database 15b stores necessary information to manage the managed devices 50. As shown in FIG. 5, the management database 15b includes, for example, a table that recites a device identifier, priority order, user, date, time, the amount of time of use, and access log. Here, FIG. 5 is an exemplary table stored in the management database 15b shown in FIG. 3.

A “device identifier” field indicates unique identification of the managed device 50, including a Media Access Control (MAC) address and a housing identifier of the managed device 50. The MAC (Media Access Control) address is to identify an information device connected to a LAN. The housing identifier is a lot number given by a manufacturer of the network device 50. The ID in FIG. 5 exemplarily uses the reference number shown in FIG. 1. A “priority order” field indicates the priority order of each group (or VLAN) into which the managed device 50 is classified. A “user” field indicates students, teachers and staffs who may use the managed device 50. The “user” field stores the ID described in the above personal information database 15a or name. A “date” field indicates the date when a user in the user field uses the managed device 50. A “time” field indicates the time when a user in the user field uses the managed device 50. An “amount of time of user” field indicates an accumulated time period of use of the managed device 50. An “access log” field indicates the history of access to the management device 10 using the managed device 50.

As discussed above, the present invention does not restrict the management database 15b from including additional fields. Therefore, an administrator may add or delete arbitrary fields or partially change the fields shown in FIG. 5 if necessary.

This management database 15b thus stores the users, data and time of use, the amount of time of use, access log of the managed devices 50, and calculates when and how long a user has used the managed device 50. Therefore, unauthorized use is easily found since a user of the managed device 50 may be specified. As will be apparent from the following description of operation, the management database 15b does not have to fill out all of the fields with information for the managed devices 50 in the table in this embodiment. As shown in FIG. 5, the table stores different information according to the managed devices 50. The management database 15b stores sufficient information for use according to security levels or the priority orders of the managed devices 50. The management database 15b stores different contents for all the groups into which the managed devices 50 are classified, and contributes to a reduced management load for the control part 11.

The interface 16 is, for example, a USB or a parallel port, and connects the management device 10 to an external device as the IC card drive 20 in this embodiment. The interface 16 includes any interface irrespective of a type of data transmission method, such as parallel and serial systems, and a type a connection medium, such as a radio and wire transmissions.

The IC card drive 20 reads information from and writes information on the IC card 30. In this embodiment, the control part 11 records part or all of the personal information database 15a output through the interface 16 down onto the IC card 30. The present invention does not limit the information record carrier to the IC card 30, but may apply any other information record carrier and drive for driving the information record carrier. The IC card drive 20 may use any technique known in the art, and thus a detailed description thereof will be omitted.

The IC card 30 is issued to students, teachers, and school staffs, and serves as an authorized (or authenticated) card for admittance to school 200 and rooms 210, an authenticated card for use of a locker 220, and an authenticated card for use of the managed device 50. As described later, the managed device 50 is made available by making the IC card reader 60 in the managed device 50 read the IC card 30. The inventive management system 1 maintains the managed device 50 unavailable until the management device 10 authenticates information read from the IC card reader 60 in the managed device 50.

The IC card 30 stores part or all of the fields in the personal information table 15a for relevant people including students, teachers, and school staffs. As shown in FIG. 6, the IC card 30 exemplarily stores information including a name, an ID, a bank account number, etc., to be read by the IC card reader 60 in the managed device 50 and authenticated by the management device 10. Here, FIG. 6 shows exemplary information stored in the IC card 30. The IC card 30 stores a table for a user used for the personal information database 15a in the management device 10. It does not have to store information of all the fields in the table in the personal information database 15a, as far as it stores one or more pieces of information that may identify an individual. The IC card 30 exemplarily stores a bank account number that may be used to settle purchases in the school 200.

The IC card 30 may use unique external appearance to differentiate stored information in this embodiment. For example, the IC card 30 may indicate a letter, design, and a color or a combination of them, depending upon entrance year, directly (for example, by providing a direct indication on a case of the IC card 30) or indirectly (for example, by labeling the case of the IC card 30).

The IC card 30 is a general term that covers a smart card, an intelligent card, a chip-in card, a microcircuit (microcomputer) card, a memory card, a super card, a multi-function card, a combination card, and the like. In addition, the IC card of the present invention is not limited to a card-shaped medium, but includes any medium which is, for example, of the size of a postage stamp or smaller, i.e., very small-size one, or shaped like a coin, etc.

The interconnecting device 40 in this embodiment covers an interconnecting network device for connecting the interconnecting device 40 and the managed device 50 to the Ethernet, and includes ports 41 to which another interconnecting device 40 and managed device 50 are connected. In FIG. 1, the port 41 is indicated as a rectangle. The interconnecting device 40 includes, for example, a hub, a switch, a router, any other concentrator, a repeater, a bridge, a gateway device, a PC, and a wireless interconnecting device (e.g., an access point as a interconnecting device for wireless LAN).

The present embodiment uses the Ethernet as a typical LAN for the network 100. The Ethernet is a LAN in a bus topology, and includes 10Base-T, 100Base-TX, Gigabit Ethernet, and the like. However, the present invention is applicable to other types of LAN (e.g., Token Ring), and networks other than LAN such as WAN, MAN (Metropolitan Area Network), private network, the Internet, commercial dedicated lines network (e.g., America Online), and other networks.

The managed device 50 is a network device connected to the network 100 and managed by the management device 10. The managed device 50 includes a network device, such as a hub, a switch, a router, any other concentrator, a repeater, a bridge, a gateway device, a PC, a server, a wireless interconnecting device (e.g., an access point as a interconnecting device for wireless LAN), and a game machine having a communication function.

In this embodiment, the managed device 50 has eight network devices to build the network 100 and its subnets, which includes the PC 50a for handling government of the school 200 such as test information and expenses, the PC 50b for managing students' academic information, the PC 50c available to teachers and other relevant people, the PC 50d available to the students, the PC 50e for handling settlements of purchases, the PC 50f for controlling admittance to the school 200, the PC 50g for controlling admittance to the room 210, and the PC 50h for controlling use (or lock/unlock) of the locker 220.

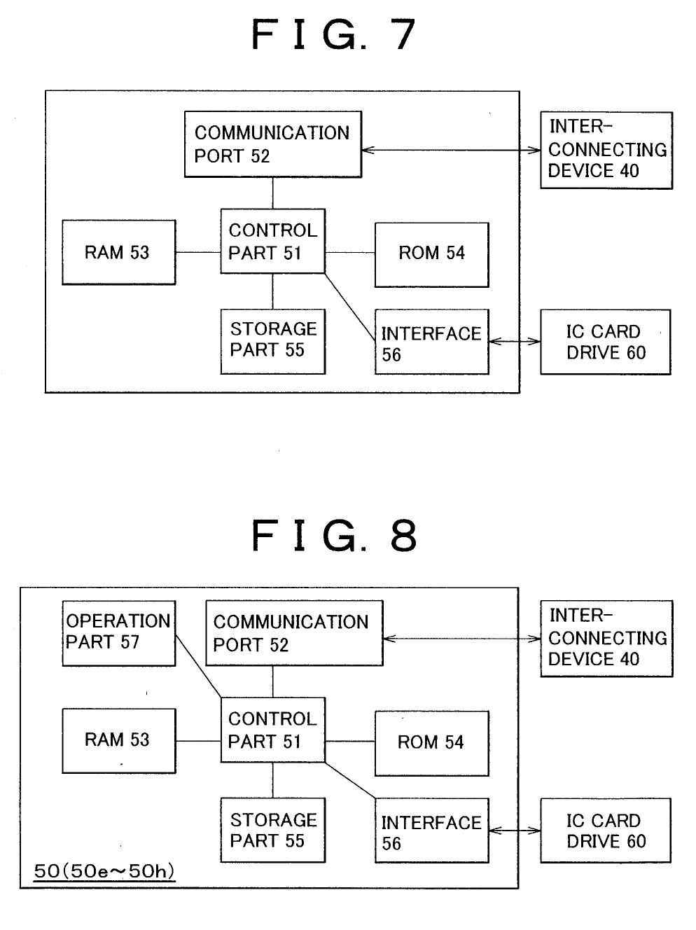

The managed device 50 includes, as shown in FIG. 7, a control part 51, a communication port 52, a RAM 53, a ROM 54, a storage part 55, an interface 56, and an IC card drive 60. Here, FIG. 7 is a schematic block diagram of the managed device 50 shown in FIG. 1. In this embodiment, the exemplary managed devices 50a-50h are network devices each implemented as a PC. FIG. 7 omits the input/output devices provided with the network device 70 for simplicity purposes. Through the input device, an operator of the managed device 50 may input various kinds of data in the storage part 55, and download necessary software into the RAM 53, and ROM 54 and storage part 55. The IC card drive 60 may be provided inside or outside the managed device 50 in FIG. 7.

The control part 51 covers a broad range of processors such as a CPU or an MPU regardless of its name, and controls each section in the managed device 50. The control part 51 may send information read from by the IC card drive 60 to the management device 10 through the communication port 52, and restricts use of the managed device 50 under control of the management device 10. As in other managed devices 50a-50h described with reference to FIG. 8, the control part 51 operates the operation part 57 to control admittance to the school 200 and room 210, lock/unlock of the locker 220, and settlement.

The communication port 52 may be an LAN adapter for establishing a connection to the network 100, and a USB port or IEEE 1394 port for providing connection to the Internet (if necessary, via an Internet Service Provider (ISP)) via a modem, or a terminal adapter (TA) through the public telephone network, ISDN, or various types of dedicated lines.

The RAM 53 temporarily stores data to be read from the ROM 54 and storage part 55, data to be written in the storage part 55, and the like. The ROM 54 stores various kinds of software and firmware necessary for operations of the control part 71, and other types of software.

The storage part 55 stores a communication parameter and a configuration program. The configuration program is a program to receive communication parameters from the management device 10, for example, corresponding the DHCP and to set up them. For example, this program may be configured based on the communication parameters given by the management device 10 or read out by the IC card 30.

The interface 56 is, for example, a USB or a parallel port, and connects the managed device 50 to the external device as the IC card drive 60 in this embodiment. The interface 56 includes any interface irrespective of a type of data transmission method, such as parallel and serial systems, and a type a connection medium, such as a radio and wire transmissions.

The IC card drive 60 reads information from and writes information into the IC card 30. The IC card drive 60 may use any technique known in the art, and thus a detailed description thereof will be omitted.

Referring to FIG. 8, the managed device 50 may have the operation part 57. Here, FIG. 8 is another exemplary block diagram of the managed device 50. This managed device 50 is a network device including the PC 50e for handling settlements of purchases, the PC 50f for controlling admittance to the school 200, the PC 50g for controlling admittance to the room 210, and the PC 50h for controlling the locker 220.

The operation part 57 opens and closes a gate at an entrance to the school 200 (e.g., for the managed device 50f) in one embodiment, opens and closes a door at an entrance to the room 210 (e.g., for the managed device 50g) in another embodiment, and locks and unlocks the locker 220 (e.g., for the managed device 50h) in still another embodiment. For example, the operation part 57 may be implemented as an automatic electronic key provided at a door. The operation part 57 may execute the settlement in another embodiment. Although FIG. 8 integrates the operation part 57 into the managed device 50a, the operation part 57 is connected to the managed device 50 through a cable.

A description will now be given of an operation of the inventive management system 1. First, an administrator classifies the managed devices 50 into one or more groups and assigns the priority order to each group, as well as creating the management database 15b.

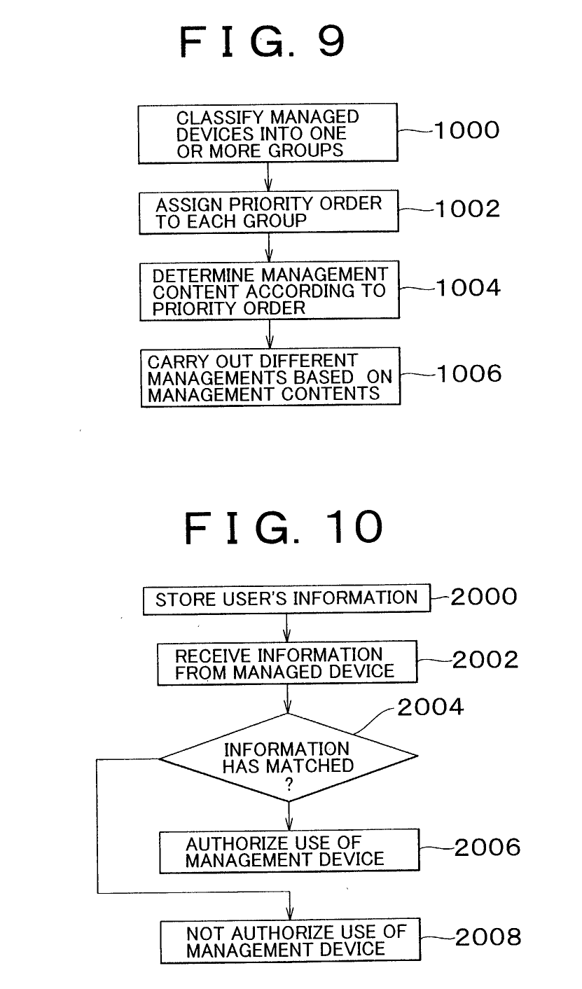

Referring to FIG. 9, the managed devices 50 are classified into groups in the network 100 (step 100). The control part 11 prompts the administrator to enter the number of groups to classify the managed devices 50 on the network 100 and its subnet, and then sets up the number of groups in response to the entry. The administrator determines the number of groups, for example, according to the number of managed devices 50 and their security levels.

As discussed, the network 100 is exemplarily connected to eight managed devices 50 including the PC 50a for handling government of the school 200 such as test information and expenses, the PC 50b for managing students' academic information, the PC 50c available to teachers and other relevant people, the PC 50d available-to the students, the PC 50e for handling settlements of purchases, the PC 50f for controlling admittance to the school 200, the PC 50g for controlling admittance to the room 210, and the PC 50h for controlling the locker 220. For example, when administrator decided to set up the number of groups to be four, e.g., groups 1 to 4, he enters four through the input part.

The control part 11 then prompts an entry of the managed devices 50 to be classified into each group, and sets up them according to the entry. For example, the control part 11 displays icons of a name and function of the managed device 50 on the network 100 and its subnet so that the icon may be clicked for each group for setup. The unclassified managed device 50 may be highlighted by deleting their icons from the display part. The control part 11 repeats until all the managed devices 50 are classified into groups.

This embodiment classifies the PC 50a for handling government of the school 200 such as test information and expenses, the PC 50b for managing students' academic information, the PC 50c available to teachers and other relevant people, into group 1, the PC 50d available to the students into group 2, the PC 50e for handling settlements of purchases into group 3, the PC 50f for controlling admittance to the school 200, the PC 50g for controlling admittance to the room 210, and the PC 50h for controlling the locker 220 into group 4. Of course, the administrator may arbitrarily classify the managed devices 50, and the number of groups is not limited to four.

Then, the priority order is assigned to each group (step 1002). The control part 11 prompts the administrator to enter the priority order for each group, and sets it up according to the entry. The control part 11 may indicate icons corresponding to the groups 1-4 and the managed devices 50 in these groups, and prompts the user to click in the ascending order of the priority. In this embodiment, the priority orders 1 to 4 are assigned to groups 1 to 4, respectively.

The management content corresponding to the priority order is determined (step 1004). The control part 11 prompts the administrator to enter the management content for each priority order, and sets it up according to the entry. For example, the control part 11 selects the management content from “user”, “date”, “time”, “the amount of time of use”, “access log”, etc. for each group. This embodiment sets all the items for the group 1, “user”, “date”, “time”, and “amount of time” for the group 2, “user”, “date” and “time” for the group 3, “user and “date” for the group 4.

When the managed devices 50 are classified into groups and the priority order is assigned to each group, the control part 11 prepares part of the table based on the set items in the management database 15b, and starts management by referring to it (step 1006). As shown in FIG. 5, the management database 15b is prepared and the management history of the managed device 50 is recorded as will be apparent from the following description of the operation.

At the same time, the administrator sets the interconnecting device 40 so that a different VLAN is assigned to each group of managed devices 50. The VLAN may use any known method, such as a port base VLAN and a MAC address VLAN. Of course, the VLAN into the interconnecting device 40 may be automatically (through software) set up in the above steps, for example, when the managed devices 50 are classified into groups in the above steps. Alternatively, the administrator may set up the interconnecting device 40 after creating the management database 15b.

The management device 10 should store the management database 15b in the storage part 15, but it does not have to create the management database 15b. Therefore, it may store the management database 15b created by another PC, etc. In this case, the above steps 1002-1006 are omitted and the management database 15b stored in the storage part 15 is executed.

The administrator then creates the personal information database 15a in the management device 10. The personal information database 15a is formed, for example, at the time of entrance or moving-in of a student. Information included in the field is collected by mail etc. before the entrance or moving-in or by interview after the entrance or moving-in. The administrator may rewrite and add the personal information database 15a if needed. The control part 11 prompts the administrator to enter a name and stores it in the “name” field in the personal information database 15a if needed. Then, the control part 11 prompts the administrator to enter other information necessary to fill out the fields in the personal information database 15a, and stores the information in the fields. The personal information database 15a does not have to store all pieces of the above information as far as it stores necessary information for management. For example, the name, ID and access right are required for the fields. The administrator may enter these pieces of information later. As the personal information database 15a is used for authentication of information stored in the IC card 30, the personal information database 15a when storing much information may keep the high security level of the authentication.

When the communication parameter of the network 100 to be assigned to the managed devices 50 is given to the individual as an ID, the control part 11 may assign a different communication parameter in each ID field. The communication parameter is, for example, an IP address, a subnet mask, a default gateway, etc., and the ID may use one communication parameter or a combination of more than one communication parameters.

The administrator stores the personal information database 15a in the IC card 30 through the IC card drive 20 in order to make the IC card 30 available to the relevant people in the school. The administrator obtains information corresponding to an individual who possesses the IC card 30 from the personal information database 15a in the storage part 15, and stores it in the IC card 30 through the IC card drive 20. As discussed above, the IC card 30 does not have to store all pieces of information in the personal information database 15a as far as it stores information necessary to retrieve and authenticate the database 15a. Information includes, for example, information stored in the name field and ID field.

As in this embodiment, the administrator may obtain information relating to the bank account field in the personal information database 15a and stores it into the IC card 30 through the IC card drive 20. Thereby, the IC card 30 in this embodiment serves as a credit or cash card for settlement as well as authentication card.

Referring now to FIG. 10, a detailed description will be given of an operation of the management device 10 in the inventive management system 1. The relevant people including students, teachers and school staffs have their IC cards 30 storing their personal information. A description will now be given of the management operation by the inventive management system 1 as well as the typical operation of the managed device 50. The storage part 15 in the management device 10 stores the personal information database 15a and management database 15b which are apparent from the above operations (step 2000). When the relevant person enters the school 200, he uses the managed device 50f, which manages the admittance to the school 200. The managed device 50f is provided at the gate or the door of the school 200.

First, the relevant person make the IC card drive 60 read the IC card 30 in the managed device 50f in entering the school 200. The information read by the IC card reader 200 is sent to the control part 51 through the interface 56 (step 2002). Thereby, the control part 51 obtains information stored in the IC card 30. Then, the control part 51 sends the read information to the management device 10 through the communication port 52. When the IC card 30 stores the communication parameter, the control part 51 may install the communication parameter in the managed device 50f.

When the management device 10 receives this information from the communication port 12, the control part 11 refers to the personal information database 15a and determines whether the received information exists in the personal information database 15a. The control part 11 retrieves the personal information database 15a, for example, using the name and ID. When the communication parameter is independently installed, the communication parameter may be used to retrieve the personal information database 15a. The control part 11 records, when finding the match in the personal information database 15a, the communication log with the IC card 30 in the management database 15b.

More specifically, the control part 11 specifies the sender managed device 50f, for example, based on the MAC address included in the information which the management device 10 has received, and retrieves each field corresponding to the managed device 50f in the management database 15b. The control part 11 first reads out the priority order field and determines whether a user of the IC card 30 that has sent the information is entitled to access the managed device 50f. The control part 11 obtains information stored in the access right field in the personal information database 15a (or when the IC card 30 has already stored this information the control part 11 extracts the information relating to the access right), and determines whether the user of the IC card 30 may have an access right by confirming the match referring to the priority order field of the management database 15b.

When determining that the user of the IC card 30 has an access right, the control part 11 records the user and data in the corresponding fields in the management database 15b. The control part 11 notifies the managed device 50a to authenticate the IC card 30 through the communication port 12 (step 2006).

When determining that the user of the IC card 30 has no access right, the control part 11 notifies the managed device 50f not to authenticate the IC card 30 through the communication port 12 (step 2008). Even when the control part 11 determines that the user of the IC card 30 has no access right, the control part 11 may record the user and date in the corresponding fields in the management database 15b. A record of information on unauthorized users would enable to the administrator to refer to the history and to manage the access including elimination of unauthorized access.

When the control part 11 cannot find information read from the IC card 30 in the personal information database 15a after retrieving the personal information database 15a, the control part notifies the managed device 50a not to authenticate the IC card 30 through the communication port 12 (step 2008).

When the managed device 50f receives a message from the management device 10 through the communication port 52 that the IC card 30 is authenticated, the control part 51 instructs the operation part 57 to unlock the key. As a result, the relevant person having the IC card 30 may enter the school 200. The managed device 50a may indicate a message, such as “entry permitted” on the display part (not shown).

When the managed device 50f receives from the management device 10 through the communication port 52 that the IC card 30 is not authenticated, the control part 51 instructs the operation part 57 to keep the key locked. The managed device 50a may indicate a message, such as “entry not permitted”, on the display part (not shown). As a result, an authorized person cannot enter the school 200.

According to the instant management system, the use of the IC card 30 enhances the security. Even though an authorized person knows the username/password, etc., he cannot enter the school without the IC card 30. In addition, according to the management system 1 of this embodiment, the management device 10 records history information including a user and use time of the relevant people for use with various applications.

The device 50g for controlling admittance to the classroom, and the device 50h for managing use of lockers 220 also serve in a similar fashion, and thus a description thereof will be omitted.

Another embodiment supposes a student uses a PC implemented as the managed device 50d in the school 200.

A student first makes the IC card drive 60 of the managed device 50d read his IC card 30. The information read by the IC card drive 60 is sent to the control part 51 through the interface 56, and the control part 51 thus obtains the information stored in the IC card 30. Then, the control part 51 sends the read information to the management device 10 through the communication port 52. When the IC card 30 stores the communication parameters, the control part 51 installs the communication parameter in the managed device 50d.

When the management device 10 receives this information through the communication port 12, the control part 11 refers to the personal information database 15a and determines whether the received information exists in the personal information database 15a. The control part 11 retrieves the personal information database 15a, for example, using the name and ID. When the communication parameter is independently installed, the communication parameter may be used to retrieve the personal information database 15a. The control part 11 records, when finding the match in the personal information database 15a, the communication log with the IC card 30 in the management database 15b.

The control part 11 specifies the sender managed device 50d, for example, based on the MAC address included in the information which the management device 10 has received, and retrieves each field corresponding to the managed device 50d in the management database 15b. The control part 11 first reads out the priority order field and determines whether a user of the IC card 30 that has sent the information is entitled to access the managed device 50d. The control part 11 obtains information stored in the access right field in the personal information database 15a (or when the IC card 30 has already stored this information the control part 11 extracts the information relating to the access right), and determines whether the user of the IC card 30 is may have an access right by confirming the match referring to the priority order field of the management database 15b.

When determining that the user of the IC card 30 has an access right, the control part 11 records the user and data in the corresponding fields in the management database 15b. The control part 11 notifies the managed device 50d to authenticate the IC card 30 through the communication port 12.

When determining that the user of the IC card 30 has no access right, the control part 11 notifies the managed device 50d not to authenticate the IC card 30 through the communication port 12. Even when the control part 11 determines that the user of the IC card 30 has no access right, the control part 11 may record the user and date in the corresponding fields in the management database 15b. A record of information on unauthorized users would enable to the administrator to refer to the history and to manage the access including elimination of unauthorized access.

When the control part 11 cannot find information read from the IC card 30 in the personal information database 15a after retrieving the personal information database 15a, the control part notifies the managed device 50d not to authenticate the IC card 30 through the communication port 12.

When the managed device 50d receives a message from the management device 10 through the communication port 52 that the IC card 30 is authenticated, the control part 51 allows use of the managed device 50d as a PC. For example, the control part 51 runs an OS that activates the PC 50d, etc. so as to make the PC 50d available to the user. As a result, the student of the school 200 having the IC card 30 may use the PC, access the Internet through the PC, and execute desired process using software in the PC 50d.

When the managed device 50d receives from the management device 10 through the communication port 52 that the IC card 30 is not authenticated, the control part 51 keeps the PC unavailable. For example, the control part 51 keeps inactive an OS for the PC 50d, and indicates a predetermined error message on the display part (not shown). As a result, an authorized person cannot use the PC 50d.

Another embodiment uses the managed devices 50a to 50c, i.e., those PCs for handling government of the school 200 such as test information and expenses, for managing students' academic information, and for use with teachers and other relevant people.

In using one of the managed devices 50a-50c (for example, managed device 50c), a relevant person, such as a teacher, first makes the IC card drive 60 of the managed device 50c read his IC card 30. The information read by the IC card drive 60 is sent to the control part 51 through the interface 56, and the control part 51 thus obtains the information stored in the IC card 30. Then, the control part 51 sends the read information to the management device 10 through the communication port 52. When the IC card 30 stores the communication parameters, the control part 51 installs the communication parameter in the managed device 50c.

When the management device 10 receives this information through the communication port 12, the control part 11 refers to the personal information database 15a and determines whether the received information exists in the personal information database 15a. The control part 11 retrieves the personal information database 15a, for example, using the name and ID. When the communication parameter is independently installed, the communication parameter may be used to retrieve the personal information database 15a. The control part 11 records, when finding the match in the personal information database 15a, the communication log with the IC card 30 in the management database 15b.

The control part 11 specifies the sender managed device 50d, for example, based on the MAC address included in the information which the management device 10 has received, and retrieves each field corresponding to the managed device 50c in the management database 15b. The control part 11 first reads out the priority order field and determines whether a user of the IC card 30 that has sent the information is entitled to access the managed device 50c. The control part 11 obtains information stored in the access right field in the personal information database 15a (or when the IC card 30 has already stored this information the control part 11 extracts the information relating to the access right), and determines whether the user of the IC card 30 is may have an access right by confirming the match referring to the priority order field of the management database 15b.

When determining that the user of the IC card 30 has an access right, the control part 11 records the user and data in the corresponding fields in the management database 15b. The control part 11 notifies the managed device 50c of the authentication of the IC card 30 through the communication port 12.

When determining that the user of the IC card 30 has no access right, the control part 11 notifies the managed device 50c of the non-authentication of the IC card 30 through the communication port 12. Even when the control part 11 determines that the user of the IC card 30 has no access right, the control part 11 may record the user and date in the corresponding fields in the management database 15b. A record of information on unauthorized users would enable to the administrator to refer to the history and to manage the access including elimination of unauthorized access.

When the control part 11 cannot find information read from the IC card 30 in the personal information database 15a after retrieving the personal information database 15a, the control part notifies the managed device 50c of the non-authentication of the IC card 30 through the communication port 12.

When the managed device 50c receives a message from the management device 10 through the communication port 52 that the IC card 30 is authenticated, the control part 51 allows use of the managed device 50c as a PC. For example, the control part 51 runs an OS that activates the PC 50d, etc. so as to make the PC 50d available to the relevant person, such as a teacher. As a result, the teacher of the school 200 having the IC card 30 may use the PC 50c to accomplish his job, communicate with PCs 50a and 50b for managing academic scores, and use or update students' personal information. The management device 10 monitors the interconnecting device 40, and fills out the access log field in the management database 15b when finding that a user of the managed device 50c has accessed another managed device (such as the managed device 50a). When the managed device 50c logs off the network 100 or turns off, etc., the control part 11 records the amount of time of use.

When the managed device 50c receives from the management device 10 through the communication port 52 that the IC card 30 is not authenticated, the control part 51 keeps the PC unavailable. For example, the control part 51 keeps inactive an OS for the PC 50d, and indicates a predetermined error message on the display part (not shown). As a result, an authorized person cannot use the PC 50d.

The inventive management system 1 thus records users who may access the managed devices 50 and access logs to the network 100, eliminating unauthorized use. The record would deter the unauthorized use.

In another embodiment, the relevant person including a student, teacher and school staff uses the managed device 50e in settlement in the school 200 (e.g., dining at a cafeteria, and purchasing stationery at a cooperative store). The managed device 50e is implemented as a PC for managing settlement of purchases.

In settlement, the relevant person, such as a student, teacher, and school staff, first makes the operation part 57 having a settlement function (such as a barcode reader) recognize information on goods, such as a barcode, for dining at a price of 500 yen at the cafeteria, and also makes the IC card drive 60 of the managed device 50e read his IC card 30. The information read by the IC card drive 60 is sent to the control part 51 through the interface 56, and the control part 51 thus obtains the information stored in the IC card 30. Then, the control part 51 sends the read information to the management device 10 through the communication port 52. When the IC card 30 stores the communication parameters, the control part 51 installs the communication parameter in the managed device 50e.

When the management device 10 receives this information through the communication port 12, the control part 11 refers to the personal information database 15a and determines whether the received information exists in the personal information database 15a. The control part 11 retrieves the personal information database 15a, for example, using the name and ID. When the communication parameter is independently installed, the communication parameter may be used to retrieve the personal information database 15a. The control part 11 records, when finding the match in the personal information database 15a, the communication log with the IC card 30 in the management database 15b.

The control part 11 specifies the sender managed device 50e, for example, based on the MAC address included in the information which the management device 10 has received, and retrieves each field corresponding to the managed device 50e in the management database 15b. The control part 11 first reads out the priority order field and determines whether a user of the IC card 30 that has sent the information is entitled to access the managed device 50e. The control part 11 obtains information stored in the access right field in the personal information database 15a (or when the IC card 30 has already stored this information the control part 11 extracts the information relating to the access right), and determines whether the user of the IC card 30 is may have an access right by confirming the match referring to the priority order field of the management database 15b.

When determining that the user of the IC card 30 has an access right, the control part 11 records the user and data in the corresponding fields in the management database 15b. If the control part 11 has already received a bank account number from the IC card 30, it refers to the bank account number. If the control part has not yet received a bank account number from the IC card 30, the control part 11 refers to the account number field in the personal information database 15a. Then, the control part 11 settles the outstanding bills, for example, through the Internet. This approach may apply techniques known in the Internet transactions. The control part 11 then notifies the managed device 50e of the authentication of the IC card 30 or the settlement completed through the communication port 12. As the instant embodiment may include the bank account number in the IC card 30, the control part 11 does not have to refer to the personal information database 15a in the management device 10, contributing to reduction of management load of the management device 10.

When determining that the user of the IC card 30 has no access right or determines that there is no account number in the personal information database 15a, the control part 11 notifies the managed device 50e of the non-authentication of the IC card 30 through the communication port 12.

When the control part 11 cannot find information read from the IC card 30 in the personal information database 15a after retrieving the personal information database 15a, the control part notifies the managed device 50e of the non-authentication of the IC card 30 through the communication port 12.

When the managed device 50c receives a message from the management device 10 through the communication port 52 that the IC card 30 is authenticated, the control part 51 informs the user of the settlement completed through the operation part 57 (or the display part (not shown)). When the managed device 50c receives from the management device 10 through the communication port 52 that the IC card 30 is not authenticated, the control part 51 informs the user of the settlement not completed through the operation part 57 (or the display part (not shown)). As a result, only an authorized person having the IC card 30 can use the settlement on the network 100.

Thus, according to the management system 1 of the instant embodiment, the management device 10 may manage the managed devices 50 according to the priority order of each group, reducing the management load of the management device 10, for example, by reducing the management content if needed. Such a management system 1 may enhance the management level for some group, and provide a network management with high security level. The management load of the management device 10 is reduced since the management device 10 does not have to manage all of the managed devices 50a-h and may apply burdenless management for some managed devices. The inventive management system 1 uses the management device 10 to allow use of the managed device 50, admittance to the school 200 and room 210, and use of locker 220, thereby eliminating unauthorized use of PC or entry to the school.

Although the description of the above embodiments uses functionally different management devices 50, a plurality of file servers may be provided and information stored in these servers may be centrally administered for security purposes, for example, by restricting an access to such a server, managing the access history of each terminal, etc.

This inventive system and method may lessen the management load of the management device, and prevent overload of the management device although the number of managed devices increases. The management device authenticates use of the managed device, preventing unauthorized use. Thereby, the present invention may provide a highly secure management system for a facility and network, which is also reliable to users of the facility and the network environment.

What is claimed is:

1. A management system comprising:
a plurality of managed devices connected to a network and classified into one or more groups, each of which is given priority order, and
a management device, connected to the network, for managing said plurality managed devices, said management device including a control part for differently managing said managed devices in accordance with the priority order.

2. A management system according to claim 1, further comprising an interconnecting device for connecting the managed devices and management device,
wherein the control part sets up said interconnecting device so that the network may be logically divided among groups.

3. A management system according to claim 1, wherein higher priority order is given to one of the groups, which requires a higher security level,
wherein the control part manages the managed device with respect to more management items where the managed device is classified into one of the groups having the higher priority order.

4. A management system according to claim 3, wherein the management item includes a user of the managed device, date and time of use of the managed device, accumulated amount of time of use of the managed device, and access log on the network of the managed device.

5. A management system according to claim 1, wherein said managed device includes:
a drive for reading an information record carrier; and
a first communication part for communicating with said management device through the network, and for sending to said management device first information read out from the information record carrier,
wherein said management device further includes:
a storage part for storing user information on users who may use the managed devices; and
a second communication part for communicating with said managed device through the network,
wherein the control part sends second information to said managed device so as to enable a user to use said managed device when the first information received from the managed device corresponds to the user information stored in the storage part.

6. A management system according to claim 5, wherein the information record carrier is an IC card.

7. A management method for managing a network to which a plurality of managed devices and a management device are connected, said method comprising the steps of:
the management device determining a management content for a plurality of managed devices classified into one or more groups, each of which is given priority order; and
the management device performing the management content for the managed device that has logged in the network, the management content corresponding to the priority order of the managed device.

8. A management device comprising:
a communication part for communicating with a plurality of managed devices through a network; and
a control part for differently managing said managed devices in accordance with priority order that has been assigned to each of one or more groups into which the managed devices are classified.

9. A management device according to claim 8, further comprising a storage part for storing management logs for each managed device.

10. A management device according to claim 8, wherein the management includes a user of the managed device, date and time of use of the managed device, accumulated amount of time of use of the managed device, and access log on the network of the managed device.

11. A management device according to claim 8, further comprising a storage part for storing user information on users who may use the managed devices, wherein the control part sends second information to the managed device so as to enable a user to use the managed device when first information received from the managed device corresponds to the user information stored in the storage part.

12. A management device according to claim 11, wherein the user information includes a user's name, identifier assigned to the user, account number, access information necessary for the network, and communication parameter for making the managed device identifiable on the network.

13. A method for managing a plurality of managed devices connected to a network, said method comprising the steps of:
classifying a plurality of managed devices into one or more groups;
assigning priority order to each of the groups;
determining for the managed device a management content that is different according to the priority order; and
managing the managed device based on the management content determined by said determining step.

14. A method for managing a plurality of managed devices connected to a network, said method comprising the steps of:
storing in a memory different management contents according to priority order of the managed devices that have been classified into one or more groups, each of which is given the priority order; and
managing the managed device based on the management content stored in the memory.

15. A method according to claim 14, wherein said managing step records a management logs for each managed device in the memory.

16. A method for authenticating an availability of a managed device connected to a network, said method comprising the steps of:
storing, in a memory, information on users who may use the managed device;
receiving first information sent from the managed device through the network;
determining whether the first information received corresponds to the information on users stored in the memory; and
informing the managed device of second information that allows a user to use the managed device when said determining step determines that the first information corresponds to the information on users.

17. A computer program for enabling a computer to managing a plurality of managed devices connected to a network, said program comprising the steps of:
obtaining a priority order of the managed devices when the managed device accesses the network, the managed devices being classified into one or more groups, each of which is given the priority order; and
performing a management corresponding to the priority order obtained by said obtaining step.

18. A computer program for enabling a computer to authenticating an availability of a managed device connected to a network, said program comprising the steps of:
authenticating first information sent from a managed device; and
generating second information that allows a user to use the managed device.

19. A managed device connected to a network and serving as a client, comprising:
a drive for reading an information record carrier;
a communication part, connected to the network, for communicating, through the network, with a management device that manages said managed device; and
a control part that makes the managed device available when the management device authenticates information read out by said drive.

20. A managed device according to claim 19, further comprising an operation part for executing a predetermined action, wherein said control part allows said operation part to execute the predetermined action when the management device authenticates information read out by said drive.

21. A managed device according to claim 20, wherein said operation part includes a key to restrict admittance to a predetermined area, wherein said control part opens the key when the management device authenticates information read out by said drive.

22. A managed device according to claim 20, wherein said operation part includes a key to restrict use of a locker, wherein said control part opens the key when the management device authenticates information read out by said drive.

23. A managed device according to claim 20, wherein said operation part serves to settle outstanding bills, wherein said control part allows the settlement when the management device authenticates information read out by said drive.

24. A method for restricting availability of a managed device connected to a network comprising the steps of:
reading an information record carrier through a drive;
sending information read by said reading step to a management device that is connected to the network and manages the managed device;
receiving an authentication result from the management device for the information sent from said sending step; and
making the managed device available when the management device authenticates the information and making the managed device unavailable when the management device does not authenticate the information.
